(19) United States
(12) Patent Application Publication
(10) Pub. No.: US 2026/0093062 A1
(43) Pub. Date: Apr. 2, 2026

(54) OPTICAL FILTER

(71) Applicant: VIAVI Solutions Inc., Chandler, AZ (US)

(72) Inventors: Dan KIM, Santa Rosa, CA (US); Linda LINGG, Palo Alto, CA (US); Brian CABINIAN, Rohnert Park, CA (US)

(21) Appl. No.: 19/343,537

(22) Filed: Sep. 29, 2025

Related U.S. Application Data
(60) Provisional application No. 63/701,183, filed on Sep. 30, 2024.

(51) Int. Cl. G02B 5/20

(52) U.S. Cl. CPC G02B 5/208

(57) ABSTRACT

In some implementations, an optical filter includes a first material that includes at least silicon and hydrogen. The optical filter is operable to transmit greater than 92% of light associated with at least one subrange of a first spectral range from 1530 to 1565 nanometers (nm), and transmit less than 5% of light associated with at least one subrange of a second spectral range from 300 to 1500 nm.

### CROSS-REFERENCE TO RELATED APPLICATION

This Patent Application claims priority to U.S. Provisional Patent Application No. 63/701,183, filed on September 30, 2024, and entitled “MATERIAL COMPRISING AT LEAST SILICON AND HYDROGEN FOR FACILITATING FREE-SPACE OPTICAL COMMUNICATION.” The disclosure of the prior Application is considered part of and is incorporated by reference into this Patent Application.

### BACKGROUND

Free-space optical communication (FSOC) is an optical communication technology that uses light, such as laser light, propagating in free space to wirelessly transmit data (e.g., for telecommunications or computer networking). Inter-satellite laser links (ISLL) technology is the use of FSOC in orbit, such as to facilitate communication between satellites. For example, ISLL may include a large, interconnected optical communication system comprising multiple satellites.

### SUMMARY

In some implementations, an optical filter includes a first material that includes at least silicon and hydrogen, wherein the optical filter is operable to: transmit greater than 92% of light associated with at least one subrange of a first spectral range from 1530 to 1565 nanometers (nm), and transmit less than 5% of light associated with at least one subrange of a second spectral range from 300 to 1500 nm.

In some implementations, an optical communication terminal includes an optical filter that comprises a first material that includes at least silicon and hydrogen, wherein the optical filter is operable to: transmit greater than 92% of light associated with at least one subrange of a first spectral range from 1530 to 1565 nm; and transmit less than 5% of light associated with at least one subrange of a second spectral range from 300 to 1500 nm.

In some implementations, an optical node includes an optical communication terminal that includes an optical filter that comprises a first material that includes at least silicon and hydrogen, wherein the optical filter is operable to: transmit greater than 92% of light associated with at least one subrange of a first spectral range from 1530 to 1565 nm; and transmit less than 5% of light associated with at least one subrange of a second spectral range from 300 to 1500 nm.

### BRIEF DESCRIPTION OF THE DRAWINGS

FIG. 1 illustrates a solar spectrum plot.

FIG. 2 is a diagram of an example implementation associated with an optical component.

FIGS. 3A-3F are diagrams of an example implementation associated with an optical component.

FIG. 4 is a diagram of example components of a device associated with an optical component.

FIGS. 5A-5B show plots of optical transmission for an optical component described herein.

FIG. 6 shows a plot of optical transmission for an optical component described herein and for another optical component.

FIG. 7 is a diagram of an example implementation of an optical communication terminal.

### DETAILED DESCRIPTION

The following detailed description of example implementations refers to the accompanying drawings. The same reference numbers in different drawings may identify the same or similar elements.

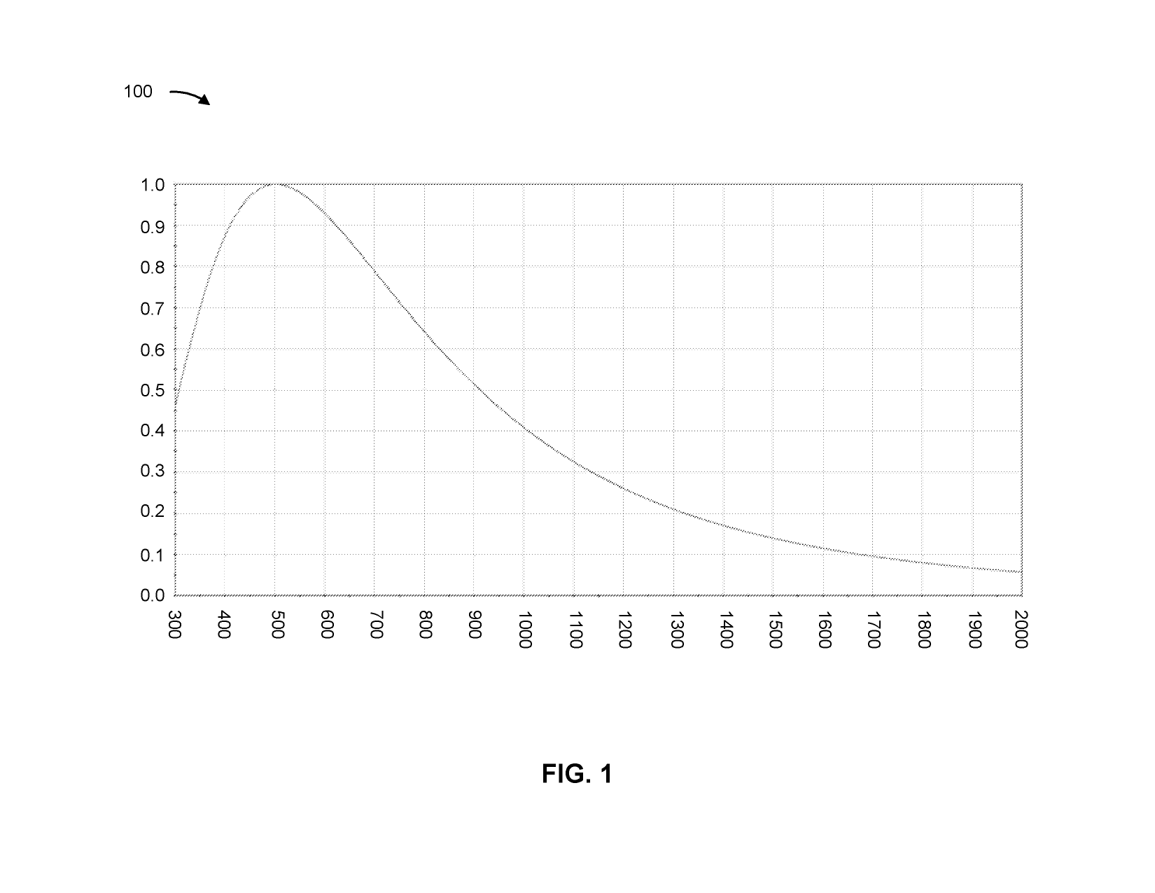

FIG. 1 illustrates a solar spectrum plot (with a horizontal axis showing wavelength, in nanometers (nm), and a vertical axis showing an intensity of light, in watts per square meter, normalized from 0.0 to 1.0), which shows a high intensity of solar radiation in the range of approximately 300 nm to 1000 nm. This portion of the spectrum corresponds to ultraviolet, visible, and near-infrared light, where solar irradiance is strongest. Because of this high intensity, optical communication devices, such as optical communication terminals, often need to implement filtering or blocking mechanisms to remove wavelengths that are of no of direct interest to the communication devices.

An optical node (e.g., an FSOC node, such as an ISLL communication node, or another type of optical node) can include one or more laser sources, one or more laser detectors, and additional optical devices for generating, processing, directing, filtering, or conditioning optical signals. One example of such an optical device is an optical communication terminal (OCT), which may integrate transmit and receive optics, detectors, filters, and alignment systems (e.g., into a single unit).

In many cases, an optical node is designed to operate in a particular communication band, such as the C-band (1530 to 1565 nm). To ensure reliable performance in this band, the optical node requires optical components that can selectively pass C-band light while effectively blocking unwanted light. For example, a portion of the solar spectrum below 1500 nm (i.e., a high-intensity portion of the solar spectrum, as shown in FIG. 1) must be blocked or attenuated. If left unfiltered, this solar background light could saturate detectors, reduce signal-to-noise ratio (SNR), cause unwanted heating, and degrade overall communication performance of the optical components of the optical node. As a result, there is increasing demand for optical components that are optimized for C-band operation while simultaneously rejecting or blocking lower-wavelength light (e.g., solar background light).

Some implementations described herein include an optical component, such as an optical filter. The optical component may be included in an optical transmission terminal, which may be included in an optical node. The optical component includes an optical coating (sometimes referred to as a filter coating) disposed on at least one surface of a substrate. The optical component is operable to provide highly selective spectral transmission or reflection characteristics, as well as absorption characteristics. For example, the optical coating is operable to transmit or reflect greater than a first threshold percentage (e.g., 92%) of light associated with at least one subrange of a first spectral range (e.g., that is associated with a communication band, such as the C-band from 1530 to 1565 nm) and to (simultaneously) transmit less than a second threshold percentage (e.g., 5%) of light associated with at least one subrange of a second spectral range (e.g., that is associated with solar background light below the first spectral range) and/or less than a third threshold percentage (e.g., 15%) of light associated with at least one subrange of a third spectral range (e.g., that is associated with solar background light above the first spectral range).

By selectively transmitting or reflecting wanted light (e.g., light associated with the first spectral range, such as C-band light) while suppressing unwanted light (e.g., light associated with the second spectral range and/or the third spectral range, such as solar background light), the optical component maximizes transmission or reflection of the wanted light. This enables a communication signal associated with the wanted light to pass or reflect with minimal insertion loss, thereby improving link margin, data rate, and overall communication reliability of the optical communication terminal and the optical node. Further, by attenuating the unwanted light, the optical component reduces a likelihood of detector saturation or noise floor elevation within the optical communication terminal and optical node, thereby improving an SNR of the optical communication terminal and optical node.

In some implementations, the optical coating of the optical component includes a first material that comprises at least silicon and hydrogen (e.g., a silicon and hydrogen (SiH) material, a hydrogenated silicon (Si:H) material, along with other examples). Accordingly, the first material may have a refractive index that is greater than or equal to 3.58 (e.g., for light associated with the first spectral range and the second spectral range). In this way, the first material may be considered to have a “high” refractive index (e.g., by having a refractive index greater than 3.5). Additionally, in some implementations, the optical coating includes a second material that comprises at least silicon and oxygen (e.g., a silicon dioxide (SiO₂) material, a silicon oxide (SiOₓ) material, where x is less than 2, along with other examples). Accordingly, the second material may have a refractive index that is less than or equal to 1.46 (e.g., for light associated with the first spectral range and the second spectral range). In this way, the second material may be considered to have a “low” refractive index (e.g., by having a refractive index less than or equal to 1.5).

Accordingly, the optical coating of the optical component may include materials with a “high” index contrast (e.g., a difference between refractive indexes that is greater than or equal to 2), which enables sharper spectral discrimination by providing greater blocking or reflectance of unwanted light (e.g., light associated with the second spectral range and/or the third spectral range, such as solar background light), higher edge steepness for selectively passing or reflecting wanted light (e.g., light associated with the first spectral range, such as C-band light), and lower transmitted wavefront error (TWE) compared to coatings made from material sets with lower index contrast. By employing only two high-index-contrast materials, the optical component can be fabricated with fewer layers and a reduced overall thickness, which not only simplifies manufacturing but can also reduce absorption in a wavelength of interest and scatter and improves mechanical stability. The two high-index-contrast materials also contribute to enhanced optical performance of the optical component over wide incident-angle ranges by minimizing angle-dependent spectral shift.

Moreover, because the optical component singularly provides selective spectral performance, additional optical elements such as external reflectors, absorbers, or bulk filters may be unnecessary, thereby reducing complexity of the optical communication terminal and optical node, component count within the optical communication terminal and optical node, and overall package size of the optical communication terminal and optical node. This reduction in size and integration of functionality into a single optical coating of the optical component allows the optical communication terminal and optical node to meet stringent form-factor requirements, improves robustness against misalignment or thermal stress, and enables deployment in platforms where compact, lightweight, and highly reliable optical communication terminals and optical nodes are essential.

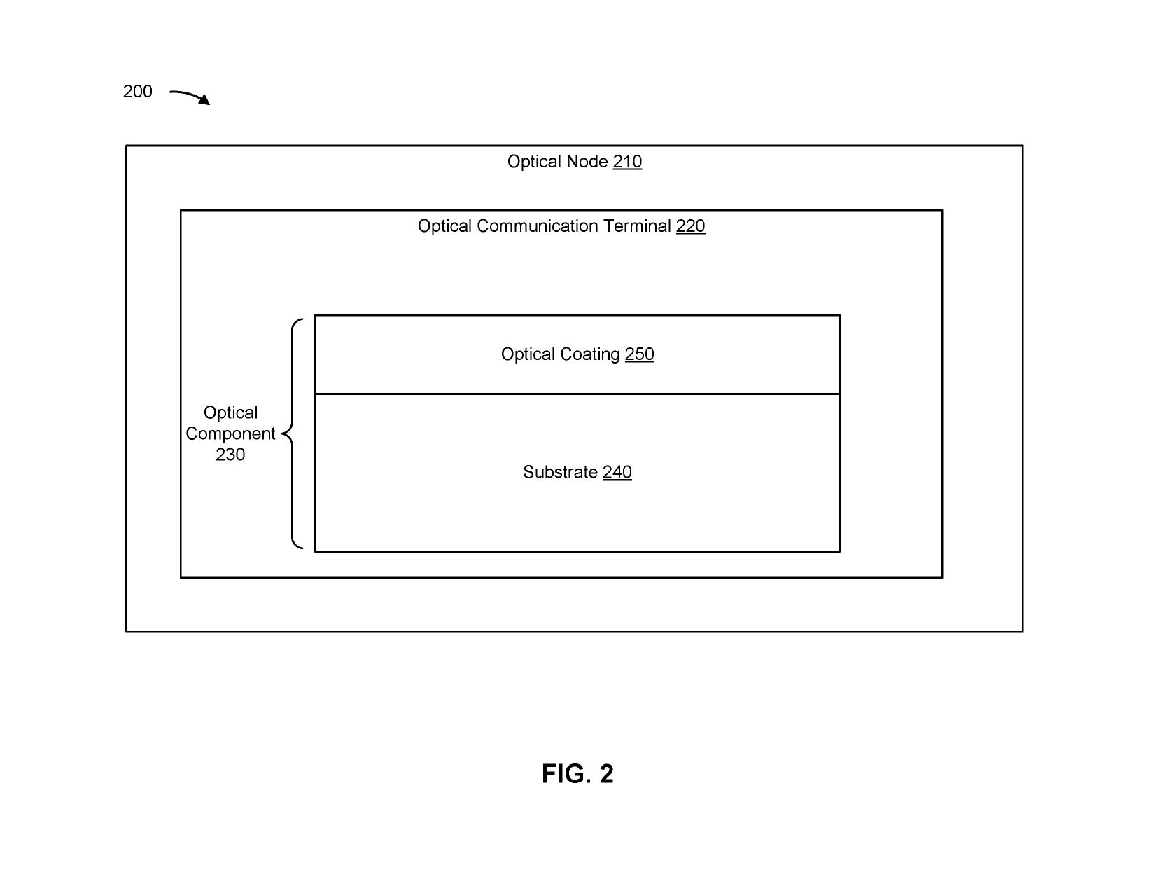

FIG. 2 is a diagram of an example implementation 200 associated with an optical component. As shown in FIG. 2, example implement 200 comprises an optical node 210, which includes an optical communication terminal 220. The optical communication terminal 220 may include an optical component 230, which comprises a substrate 240 and an optical coating 250.

The optical node 210 may be an FSOC node, such as ISLL communication node, or another type of optical node configured for terrestrial, maritime (including littoral), airborne, space-based, or another type of operation. The optical node 210 may operate in a particular communication band, such as the C-band (1530 to 1565 nm).

In some implementations, the optical node 210 includes an optical communication terminal 220, such as a laser source, a laser detector, or another type of optical device for directing, filtering, or conditioning an optical signal. The optical communication terminal 220 may also include optical elements, such as beam steering or tracking mechanisms, to facilitate alignment of the optical node 210 with counterpart optical nodes.

The optical communication terminal 220 may include an optical component 230. The optical component 230 may include, or may be included in, an optical filter, such as a sun-blocking filter, an amplified spontaneous emission filter, an edge filter, a dichroic filter, or a narrowband filter, or another type of optical component, such as a beamsplitter, an aperture sharing element, a channel separator, a reflector, an anti-reflection coating, or a partial reflector.

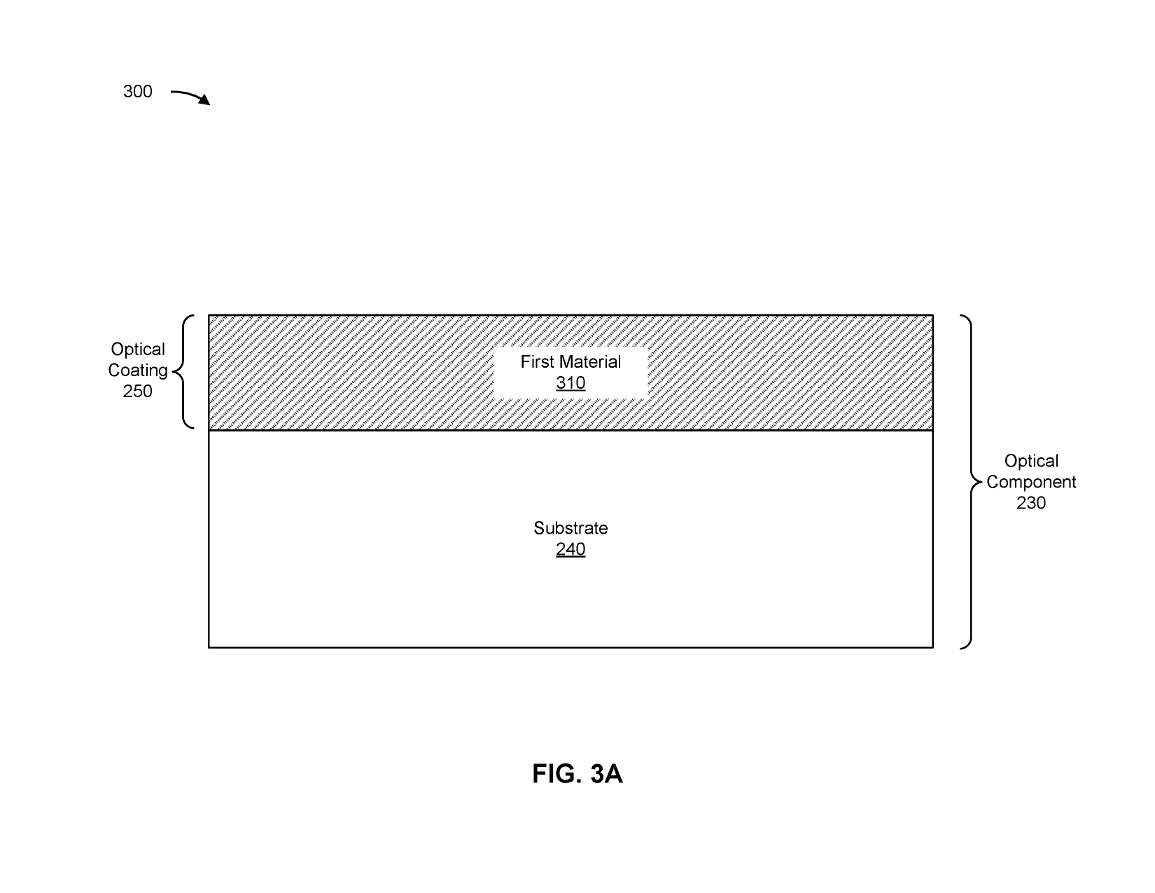

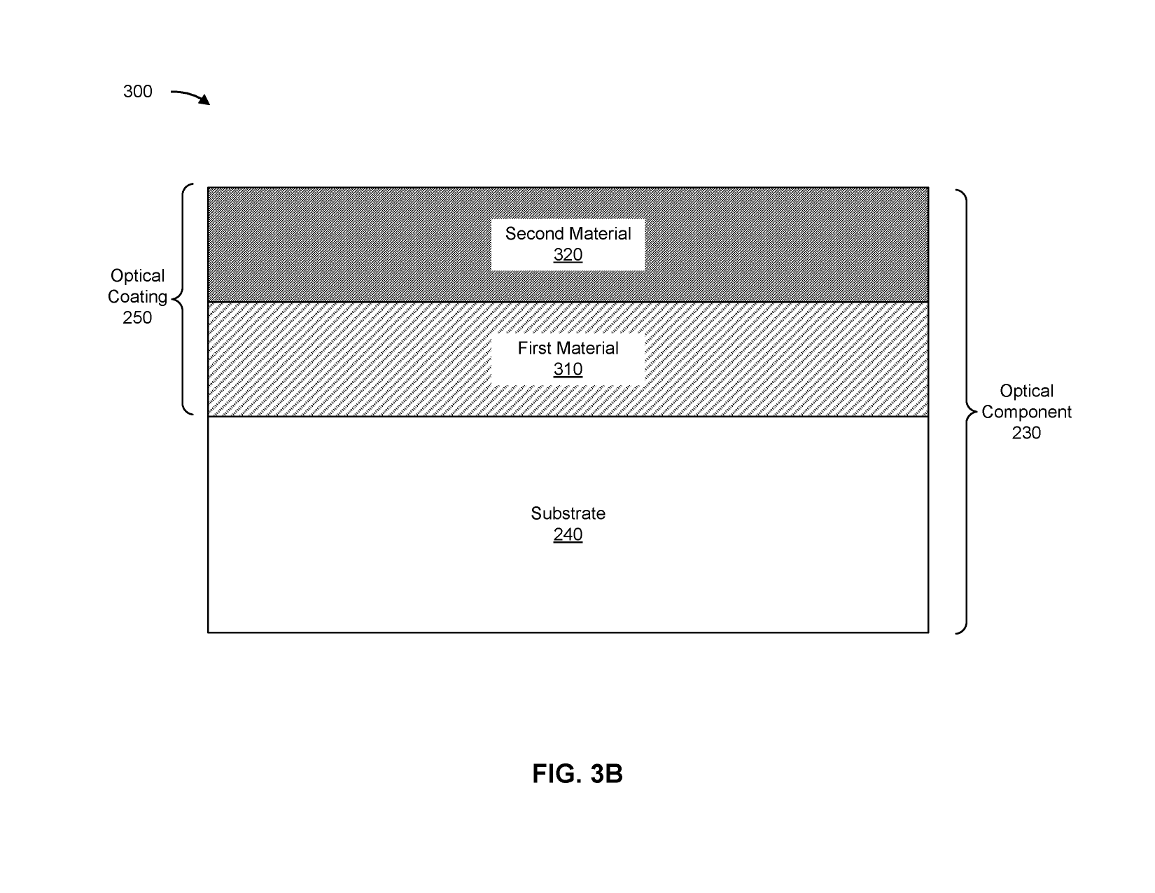

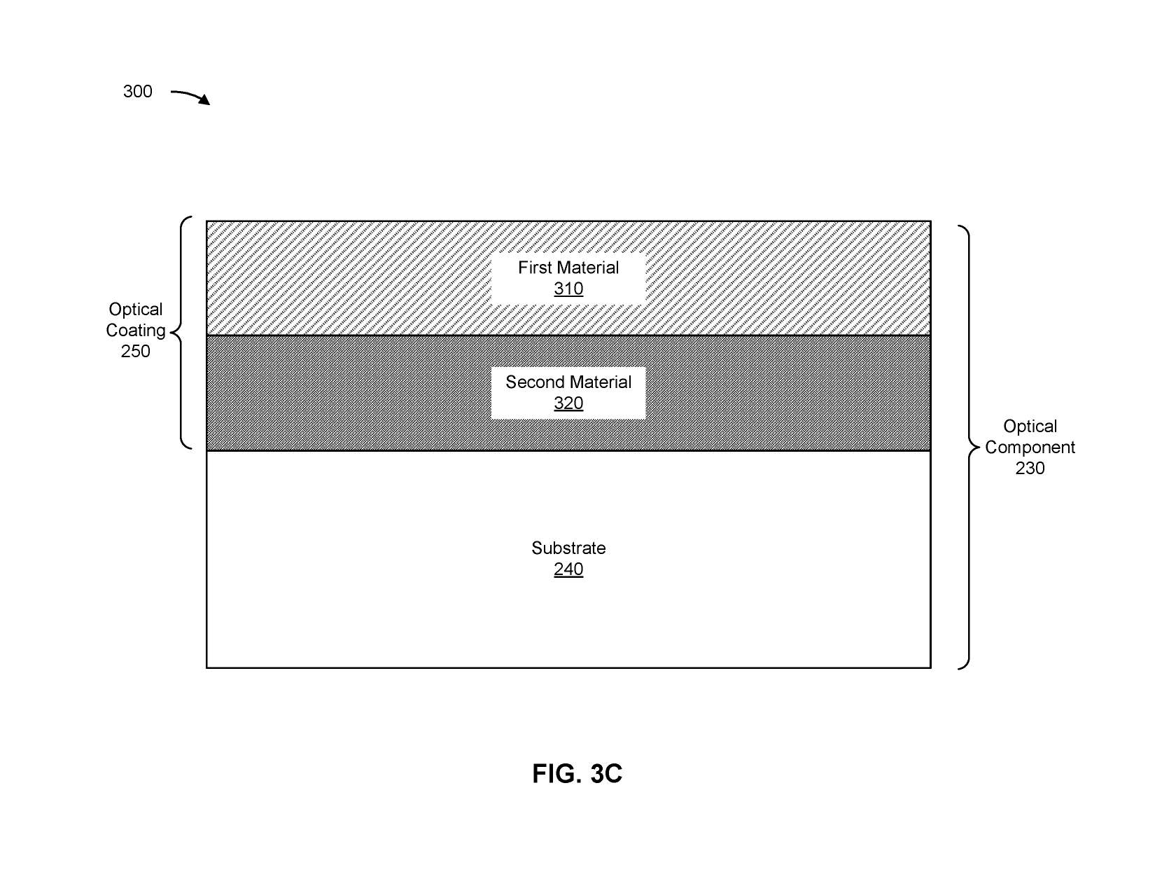

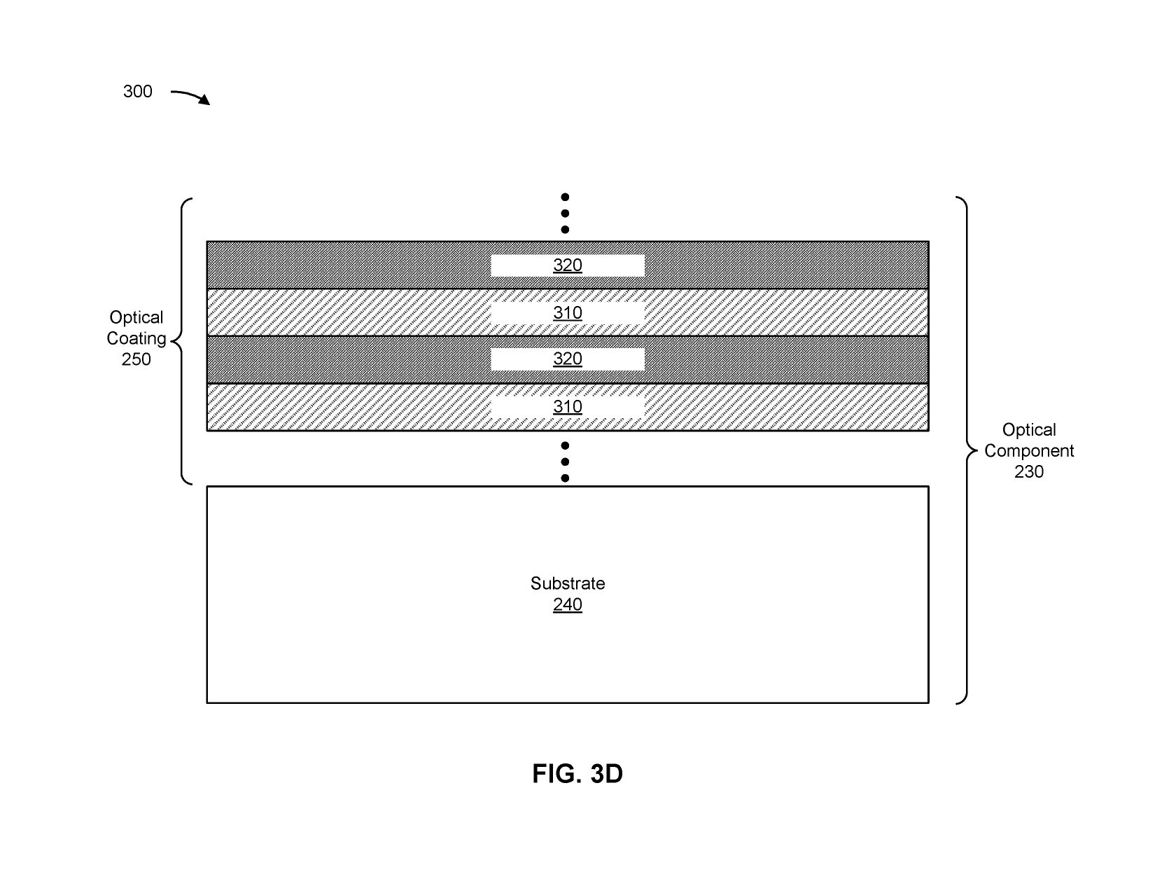

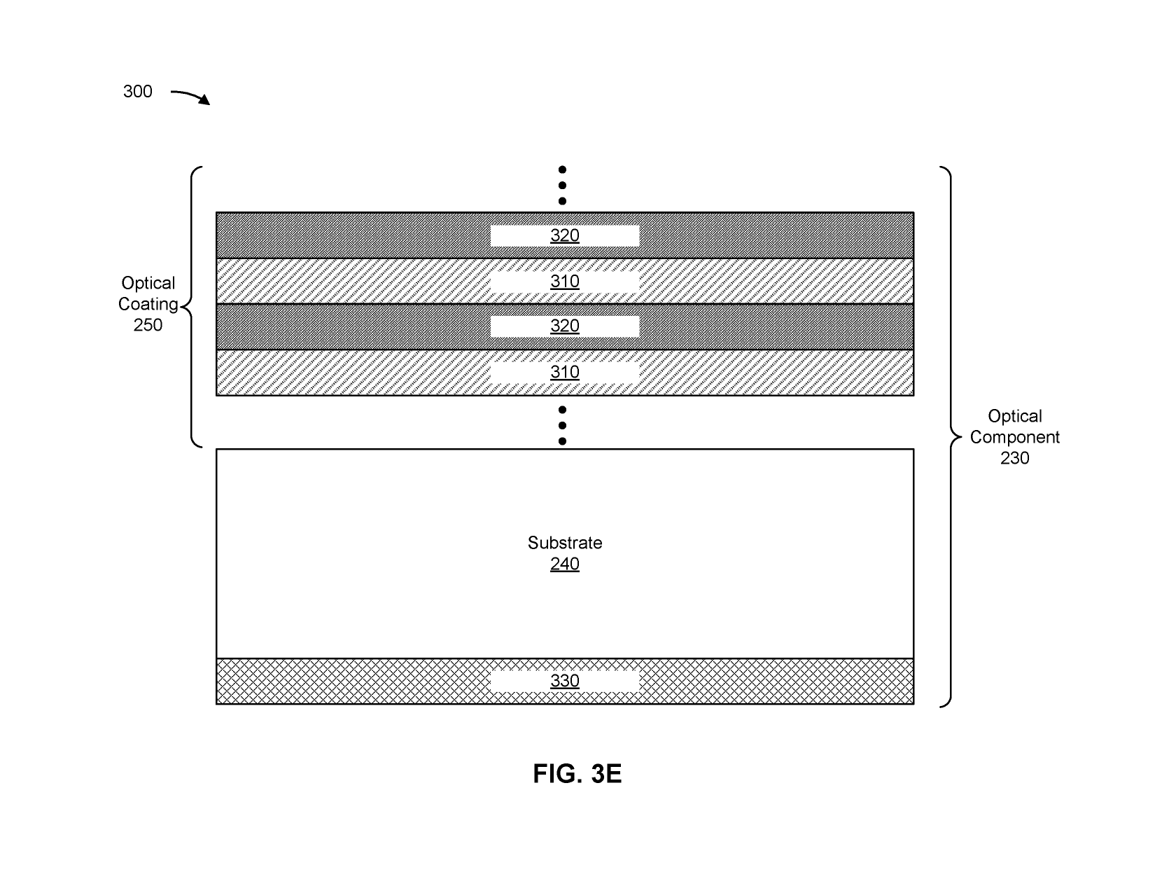

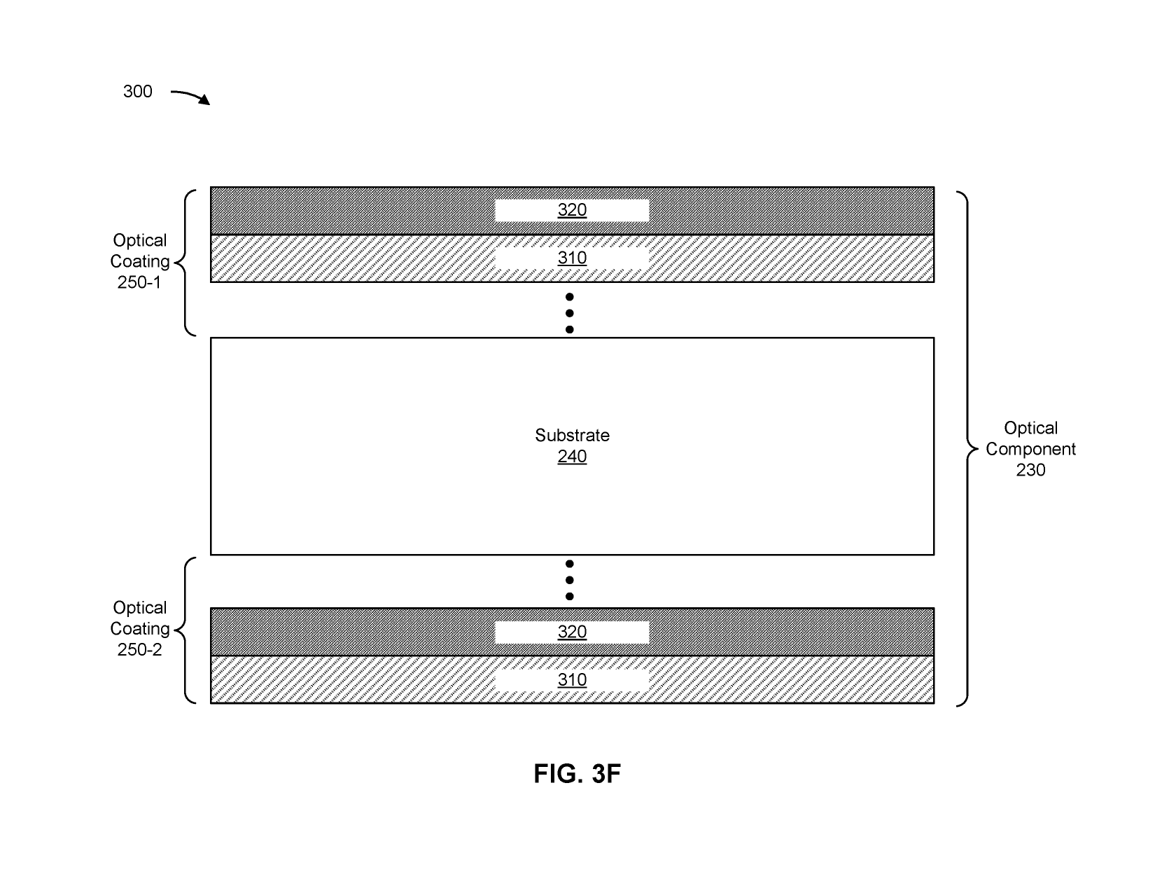

The optical component 230 may include the substrate 240 and the optical coating 250. The substrate 240 may comprise a glass substrate, a glass-ceramic substrate, a crystal substrate, a polymer substrate, a polycarbonate substrate, a metal substrate, a silicon (Si) substrate, a germanium (Ge) substrate, or another type of substrate. The optical coating 250 may be disposed on at least one surface of the substrate 240, as further described herein in relation to FIGS. 3A-3F.

The optical component 230 is operable to provide highly selective spectral transmission or reflection characteristics. For example, the optical component 230 is operable to transmit or reflect (e.g., transmit only, reflect only, or a combination of transmit and reflect) greater than a first threshold percentage (e.g., 92%) of light associated with at least one subrange of a first spectral range (e.g., that is associated with the particular communication band of the optical node 210, such as the C-band from 1530 to 1565 nm) and to (simultaneously) transmit less than a second threshold percentage (e.g., 5%) of light associated with at least one subrange of a second spectral range (e.g., that is associated with solar background light below the first spectral range). In some implementations, the second spectral range is from 100 to 1500 nm, 120 to 1500 nm, 200 to 1500 nm, 300 to 1500 nm, 700 to 1500 nm, 900 to 1500 nm, or another range up to 1500 nm (these ranges account for the dominant spectral components of solar irradiance and atmospheric scattering, which can impair optical communication, such as FSOC). A width of a subrange, of the at least one subrange of the second spectral range, may be greater than a width of the first spectral range (because interference sources can span broader spectral regions than a narrowly defined communication band, such as the C-band).

In some implementations, the optical component 230 is operable to transmit greater than 92% of light associated with a first subrange of the first spectral range and to reflect greater than 92% of light associated with a second subrange of the first spectral range, the first subrange and second subrange being non-overlapping. In this way, the optical component 230 can simultaneously support bidirectional communication or multiplexed channels within the same spectral band, improving link efficiency and enabling higher data throughput without requiring additional optical hardware.

In some implementations, the optical component 230 is operable to transmit less than a third threshold percentage (e.g., 15%) of light associated with at least one subrange of a third spectral range (e.g., that is associated with solar background light above the first spectral range). In some implementations, the second spectral range is from 1600 to 1800 nm, 1600 to 2500 nm, 1600 to 4000 nm, or another range from 1600 nm (these ranges account for other spectral components of solar irradiance and atmospheric scattering, which can impair optical communication, such as FSOC). A width of a subrange, of the at least one subrange of the third spectral range, may be greater than a width of the first spectral range (because interference sources can span broader spectral regions than a narrowly defined communication band, such as the C-band).

By selectively transmitting or reflecting wanted light (e.g., light associated with the first spectral range, such as C-band light) while suppressing unwanted light (e.g., light associated with the second spectral range and/or the third spectral range, such as solar background light), the optical component 230 maximizes transmission or reflection of the wanted light and enables a communication signal associated with the wanted light (e.g., that is received by, or is to be transmitted or reflected by, the optical node 210). In some implementations, the wanted light is able to pass or reflect with minimal insertion loss, thereby improving link margin, data rate, and overall communication reliability of the optical communication terminal 220 and the optical node 210. Further, by attenuating the unwanted light, the optical component 230 reduces a likelihood of detector saturation or noise floor elevation within the optical node 210, thereby improving an SNR of the optical node 210. In addition, the optical component 230 provides thermal protection by limiting absorption of excess solar radiation of the optical communication terminal 220 and/or the optical node 210, thereby mitigating heat buildup and preserving the performance and lifetime of sensitive optical elements.

In some implementations, a thickness of the optical component 230 (e.g., a maximum thickness of the optical component 230, measured perpendicularly to a surface of the substrate 240 on which the optical coating 250 is disposed) is less than or equal to a thickness threshold. The thickness threshold may be, for example 10 micrometers (µm). The optical component 230 having a thickness that is less than or equal to the thickness threshold can reduce absorption losses, lowers stress and potential delamination risks within the optical component 230, and allows the optical component 230 to maintain high optical quality and durability while supporting compact, lightweight designs. Further details related to the optical component 230 are described herein.

As indicated above, FIG. 2 is provided as an example. Other examples may differ from what is described with regard to FIG. 2.

FIGS. 3A-3F are diagrams of an example implementation 300 associated with an optical component. As shown in FIGS. 3A-3F, example implementation 300 includes the optical component 230, which comprises the substrate 240 and the optical coating 250, described herein in relation to FIG. 2. For example, the optical coating 250 may be disposed on at least one surface of the substrate 240, and therefore the optical component 230 may be operable to transmit or reflect greater than a first threshold percentage (e.g., 92%) of light associated with at least one subrange of a first spectral range (e.g., that is associated with the particular communication band of the optical node 210, such as the C-band from 1530 to 1565 nm) and to (simultaneously) transmit less than a second threshold percentage (e.g., 5%) of light associated with at least one subrange of a second spectral range (e.g., that is associated with solar background light below the first spectral range) and/or less than a third threshold percentage (e.g., 15%) of light associated with at least one subrange of a third spectral range (e.g., that is associated with solar background light above the first spectral range).

As shown in FIGS. 3A-3F, the optical coating 250 includes a first material 310. In some implementations, the first material 310 comprises at least silicon and hydrogen. For example, the first material 310 may comprise an SiH material, an Si:H material, a hydrogenated silicon with helium (Si:H-He) material, a hydrogenated silicon with nitrogen (Si:H-N) material, or another material that includes at least silicon and hydrogen. Accordingly (e.g., because the first material 310 comprises at least silicon and hydrogen), the first material 310 may have a refractive index that is greater than or equal to 3.58 (e.g., for light associated with the first spectral range and the second spectral range and/or the third spectral range). In some implementations, the first material 310 may have a refractive index that is greater than a first refractive index threshold (e.g., to increase an index contrast of materials of the optical coating 250, further described herein). The first refractive index threshold may be equal to, for example, 3.5. In this way, the first material 310 may be considered to have a “high” refractive index material (e.g., by having a refractive index greater than 3.5).

In some implementations, as shown in FIG. 3A, the optical coating 250 may include only the first material 310 (e.g., a single layer of the first material 310, and no other material), and the optical coating 250 may be disposed on a surface (e.g., a single surface) of the substrate 240. In some implementations, the optical coating 250 (e.g., that includes only the first material 310) may also be disposed on one or more other surfaces of the substrate 240, such as in a similar manner as that described herein in relation to FIGS. 3E-3F.

As shown in FIGS. 3B-3F, the optical coating 250 may include (e.g., in addition to the first material 310) a second material 320. In some implementations, the second material 320 comprises at least silicon and oxygen. For example, the second material 320 may comprise an SiO₂ material, an SiOₓ material, or another material that includes at least silicon and oxygen. Additionally, or alternatively, the second material 320 may comprise at least an oxide, such as a tantalum pentoxide (Ta₂O₅) material, a niobium pentoxide (Nb₂O₅) material, a niobium titanium oxide (NbTiOₓ) material, a niobium tantalum pentoxide (Nb₂₋ₓTaₓO₅) material, a titanium dioxide (TiO₂) material, an aluminum oxide (Al₂O₃) material, a zirconium oxide (ZrO₂) material, an yttrium oxide (Y₂O₃) material, or a hafnium oxide (HfO₂) material, along with other examples.

Accordingly (e.g., because the second material 320 comprises at least silicon and oxygen and/or at least an oxide), the second material 320 may have a refractive index that is less than or equal to 1.46 (e.g., for light associated with the first spectral range and the second spectral range and/or the third spectral range). In some implementations, the second material 320 may have a refractive index that is less than or equal to a second refractive index threshold (e.g., to increase an index contrast of materials of the optical coating 250, as further described herein). The second refractive index threshold may be equal to, for example, 1.5. In this way, the second material 320 may be considered to have a “low” refractive index material (e.g., by having a refractive index less than or equal to 1.5).

Accordingly, the optical coating 250 may include materials with a “high” index contrast (e.g., a difference between respective refractive indexes of the first material 310 and second material 320 that is greater than or equal to 2). Thus, including the first material 310 and the second material 320 that have a high index contrast in the optical coating 250 enables sharper spectral discrimination by providing greater blocking of unwanted light (e.g., light associated with the second spectral range and/or the third spectral range, such as solar background light) and higher edge steepness for selectively transmitting or reflecting wanted light (e.g., light associated with the first spectral range, such as C-band light). Further, the high-index-contrast materials reduce a TWE compared to coatings made from material sets with lower index contrast. By employing only two high-index-contrast materials, the optical coating 250 can be fabricated with fewer layers and a reduced overall thickness, which not only simplifies manufacturing but also reduces absorption losses in the first spectral range and improves mechanical stability of the optical coating 250 (and the optical component 230), as described elsewhere herein.

In some implementations, as shown in FIGS. 3B-3F, the optical coating 250 may include the first material 310 and the second material 320, and the optical coating 250 may be disposed on at least one surface of the substrate 240.

As shown in FIGS. 3B and 3C, the optical coating 250 may include a single layer of the first material 310 and a single layer of the second material 320. As shown in FIG. 3B, the optical coating 250 may be disposed on a surface (e.g., a single, top surface) of the substrate 240, where the single layer of the first material 310 is disposed on the surface (e.g., the top surface) of the substrate 240 and the single layer of the second material 320 is disposed on a surface (e.g., a top surface) of the first material 310. As shown in FIG. 3C, the optical coating 250 may be disposed on a surface (e.g., a single, top surface) of the substrate 240, where the single layer of the second material 320 is disposed on the surface (e.g., the top surface) of the substrate 240 and the single layer of the first material 310 is disposed on a surface (e.g., a top surface) of the second material 320.

As shown in FIGS. 3D-3E, the optical coating 250 may include multiple layers of the first material 310 and the second material 320. As shown FIGS. 3D-3E, the optical coating 250 may be disposed on a surface (e.g., a single, top surface) of the substrate 240, where the layers of the first material 310 (also referred to as A layers) and layers of the second material 320 (also referred to as B layers) are arranged in an alternating layer order, such as an (A−B)ₘ (m≥1) order, an (A−B)ₘ−A order, a (B−A)ₘ order, a B−(B−A)ₘ order, or another order, on the surface of the substrate 240. The alternating layer order may create strong constructive and destructive interference of wanted light (e.g., light associated with the first spectral range, such as C-band light), which enables sharper spectral edges and higher blocking efficiency of unwanted light (e.g., light associated with the second spectral range and/or the third spectral range, such as solar background light).

As shown in 3E, another optical coating 330 may be disposed on at least one other surface of the substrate 240. The other optical coating 330 may be, for example, an anti-reflection (AR) coating, a protective coating, or another type of coating. As shown in FIG. 3E, the other optical coating 330 is disposed on a bottom surface of the substrate 240 when the optical coating 250 is disposed on a top surface of the substrate 240.

As shown in FIG. 3F, the optical coating 250 may be disposed on multiple surfaces of the substrate 240. For example, a first portion of the optical coating 250-1 may be disposed on a first surface (e.g., a top surface) of the substrate 240 and a second portion of the optical coating 250-2 may be disposed on a second surface (e.g., a bottom surface) of the substrate 240. Each portion of the optical coating 250 may include one or more layers of the first material 310, and, in some implementations, one or more layers of the second material 320 (e.g., arranged as described elsewhere herein). By disposing the optical coating 250 on multiple surfaces of the substrate 240, the optical coating 250 distributes a filtering and/or blocking function across different interfaces, which can reduce a thickness of the optical coating 250 per surface, improve durability of the optical coating 250, enhance angular performance of the optical coating 250, and provide redundancy that maintains spectral selectivity even when one surface of the substrate 240 experiences degradation or damage.

As indicated above, FIGS. 3A-3F are provided as an example. Other examples may differ from what is described with regard to FIGS. 3A-3F. The number and arrangement of materials (e.g., of the optical coating 250) shown in FIGS. 3A-3F are provided as an example. In practice, there may be additional materials, fewer materials, different materials, or differently arranged materials than those shown in FIGS. 3A-3F.

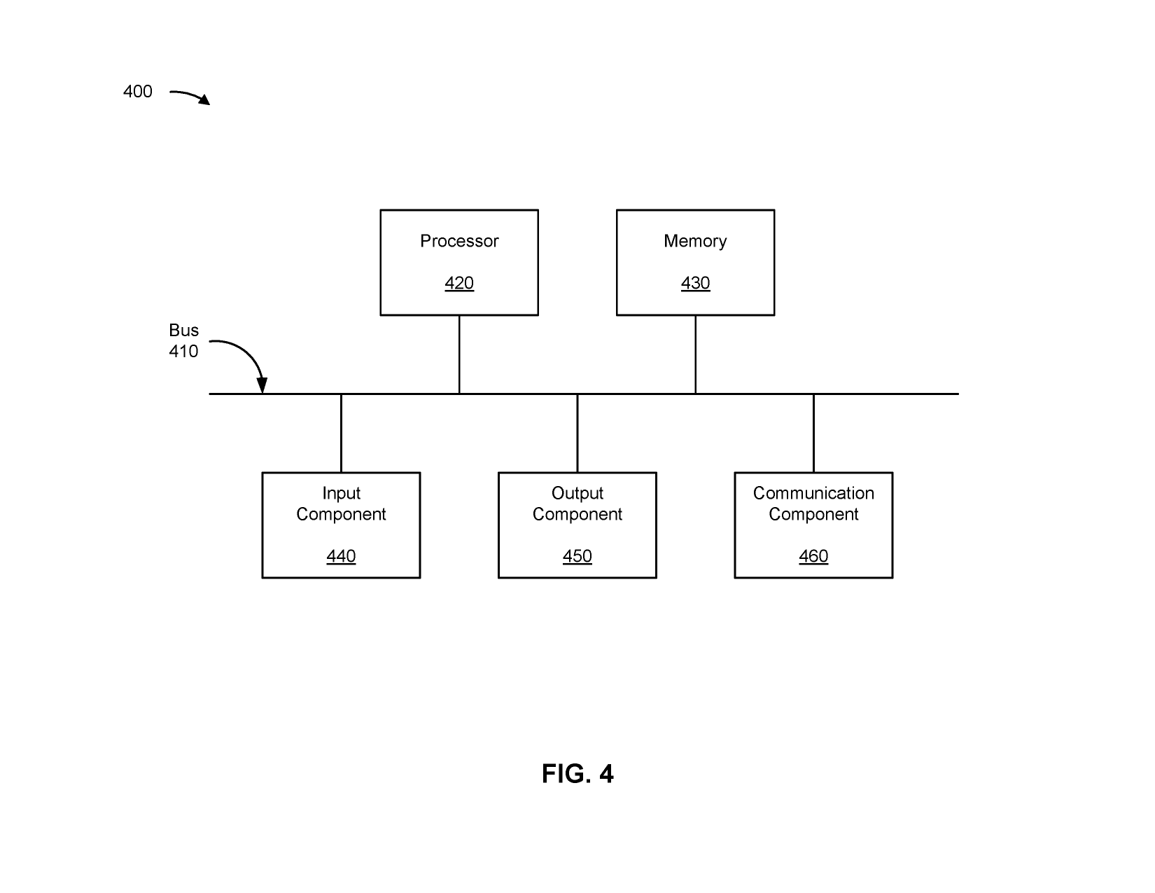

FIG. 4 is a diagram of example components of a device 400 associated with an optical component. The device 400 corresponds to one or more of the optical node 210 and/or the optical communication terminal 220. In some implementations, the optical node 210 and/or the optical communication terminal 220 includes one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

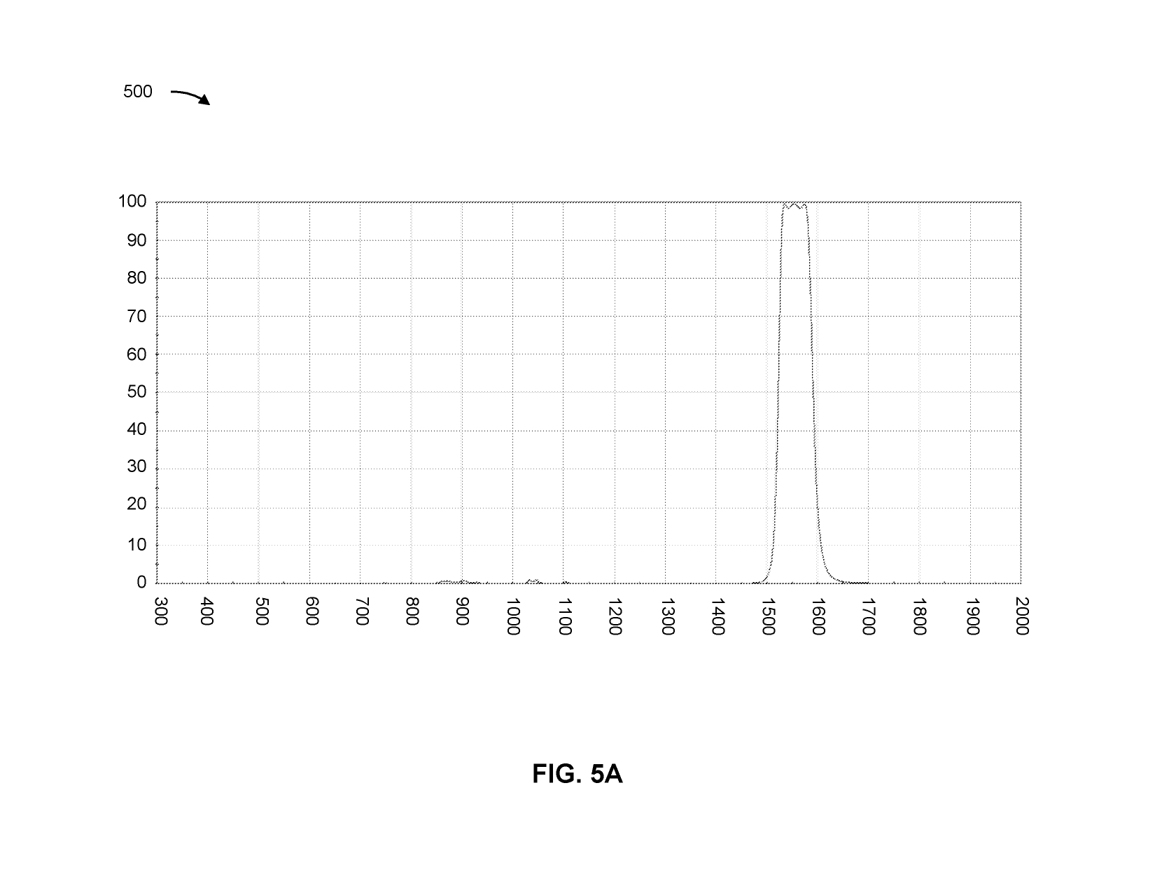

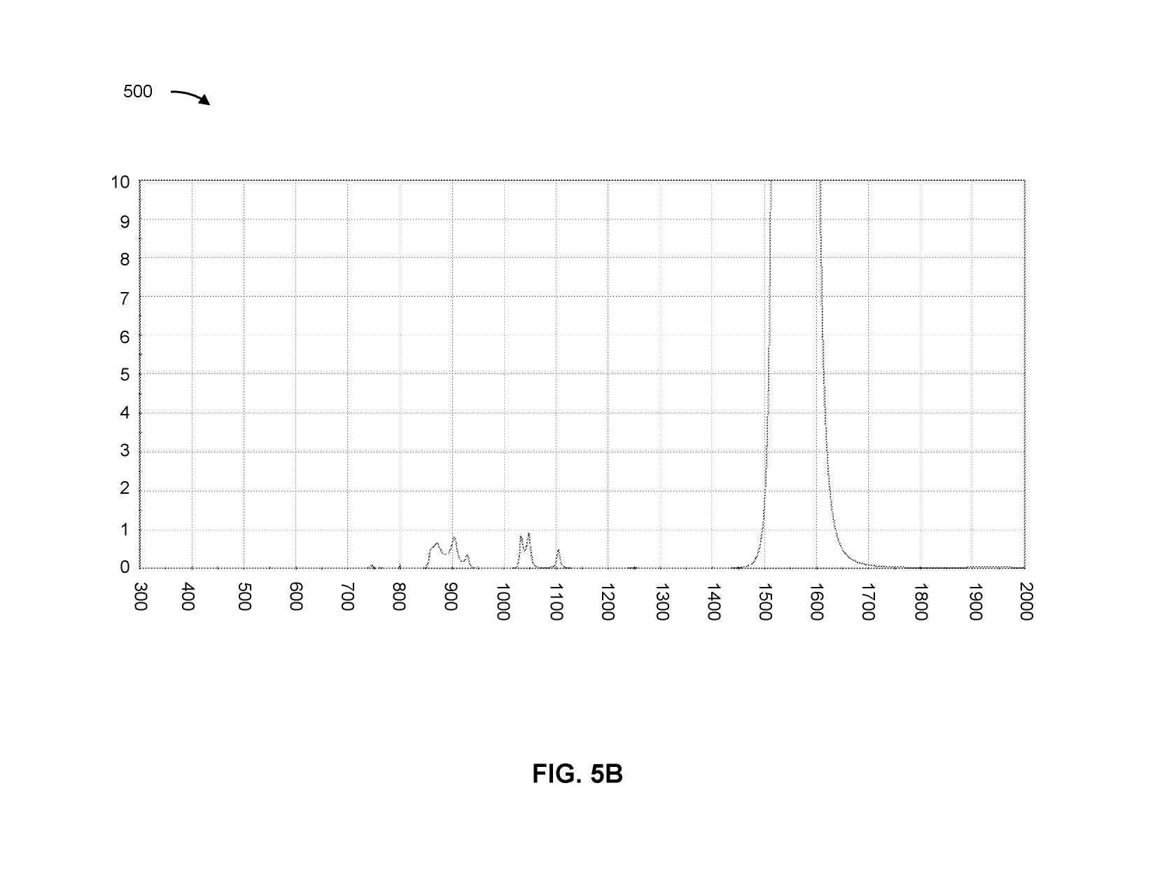

FIGS. 5A-5B show plots 500 of optical transmission (e.g., in percentage (%)) versus wavelength (e.g., in nm) for the optical component 230 described herein. The optical component 230 includes one or more layers of the first material 310 (e.g., that comprises at least silicon and hydrogen) and one or more layers of the second material 320 (e.g., that comprises at least silicon and oxygen). A thickness (e.g., a maximum thickness) of the optical component 230 is 5.6 µm. As shown in FIG. 5A, the optical component 230 transmits greater than 92% of light associated with a first spectral range from 1530 to 1565 nm. As shown in FIGS. 5A-5B, the optical component 230 transmits less than 5% of light associated with a second spectral range from 300 to 1500 nm.

As indicated above, FIGS. 5A-5B are provided as an example. Other examples may differ from what is described with regard to FIGS. 5A-5B.

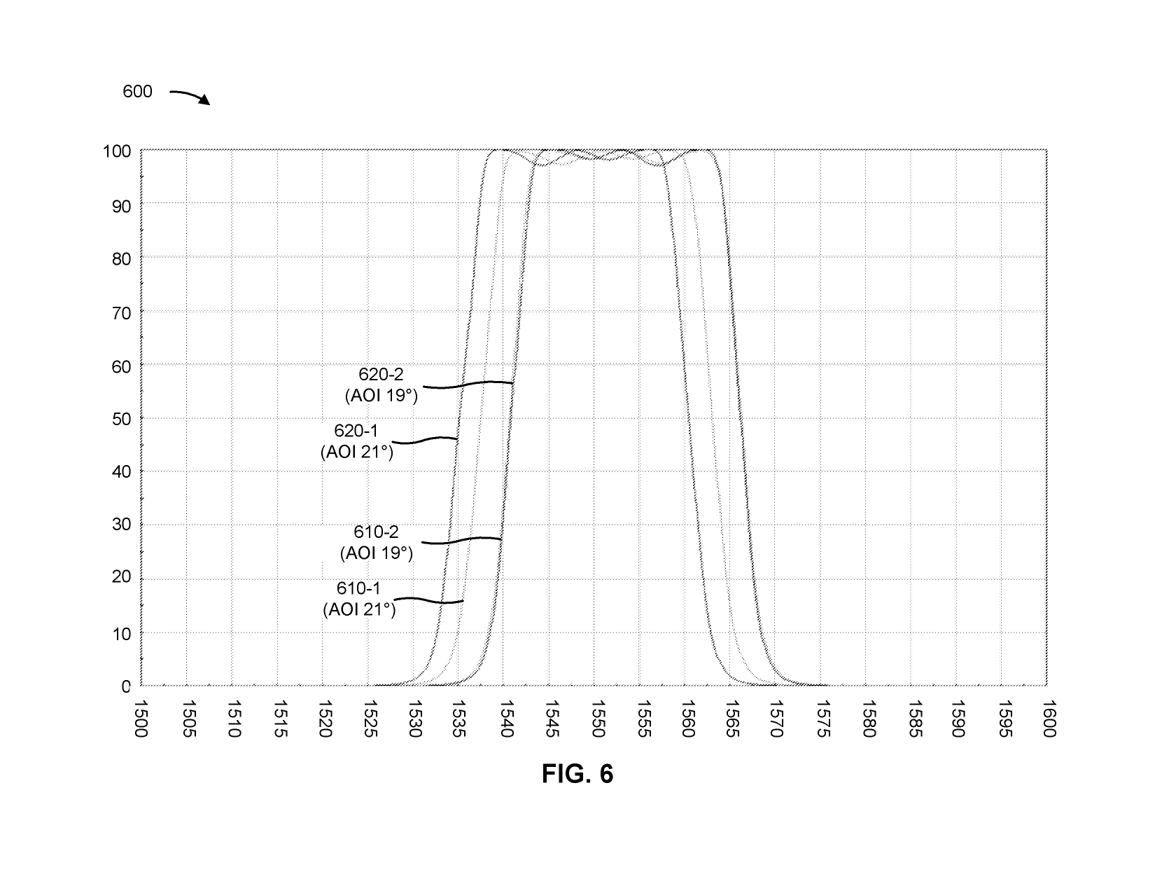

FIG. 6 shows a plot 600 of optical transmission (e.g., in percentage (%)) versus wavelength (e.g., in nm) for the optical component 230 described herein (e.g., that has a high index contrast) and for another optical component. The other optical component may include materials with a “low” index contrast (e.g., a difference between respective refractive indexes of the materials is less than 2).

The plot 600 shows curves 610-1 and 610-2 corresponding to the optical component 230, and curves 620-1 and 620-2 corresponding to another optical component, for angles of incidence (AOI) of 19° and of 21°. As illustrated in FIG. 6, the optical component 230 exhibits a lesser angle-dependent spectral separation (e.g., of 3.0 nm) compared to the angle-dependent spectral separation observed for the other optical component (e.g., of 5.5 nm). This reduced angle separation indicates that the optical component 230 maintains more stable spectral performance across varying incident angles, thereby providing enhanced optical performance and improved reliability over wide AOI ranges as compared to the other optical component.

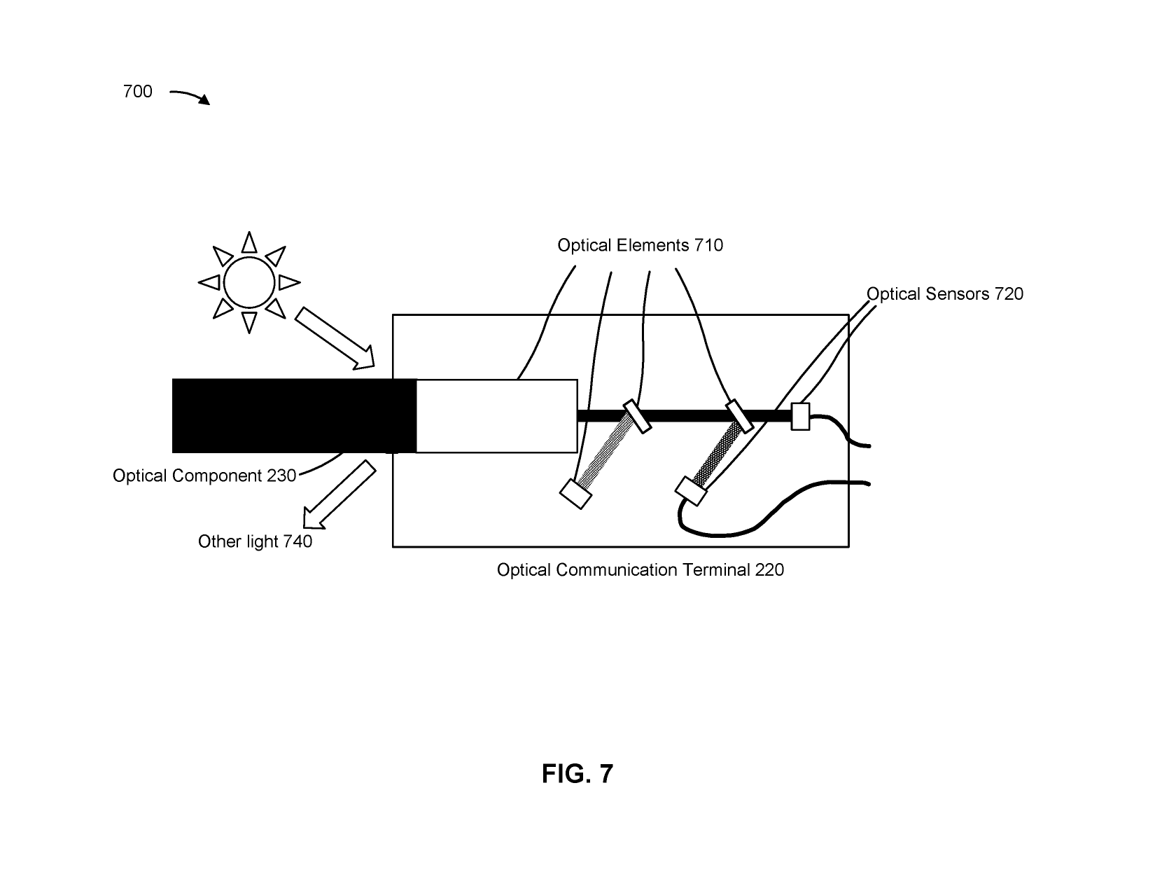

FIG. 7 is a diagram of an example implementation of an optical communication terminal 220 (e.g., of an optical node 210). As shown in FIG. 7, the optical communication terminal 220 includes an optical component 230 and a plurality of optical elements 710 (e.g., reflectors, beam splitters, lenses, or other types of optical elements) and optical sensors 720 (e.g., photodiodes, avalanche photodiodes, or other detectors for measuring optical signal intensity, alignment, or tracking). As shown in FIG. 7, the optical component 230 is positioned at input portion of the optical communication terminal 220 (e.g., within a window or aperture) and is operable to transmit communication light 730 (e.g., light associated with at least one subrange of a first spectral range, such as the C-band from 1530 to 1565 nm) and to block other light 740 (e.g., light that is associated with solar background light below and/or above the first spectral range). In some implementations, the optical component 230 (or one or more other optical components 230) may be positioned at one or more other positions within the optical communication terminal 220 (e.g., to transmit and/or reflect the communication light 730 to the optical elements 710 and the optical sensors 720, and/or to block the other light 740 from transmitting to the to the optical elements 710 and the optical sensors 720).

The foregoing disclosure provides illustration and description, but is not intended to be exhaustive or to limit the implementations to the precise forms disclosed. Modifications and variations may be made in light of the above disclosure or may be acquired from practice of the implementations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “bottom,” “above,” “upper,” “top,” and the like, may be used herein for ease of description to describe one element or feature’s relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

As used herein, the term “X material,” where X is a chemical composition, such as Ta₂O₅, SiO₂, or SiH, indicates that at least a threshold percentage of X is included in the X material. The threshold percentage may be, for example, greater than or equal to 1%, 5%, 10%, 25%, 50%, 75%, 85%, 90%, 95%, and/or 99%. Also, when a material is referred to by a specific chemical name or formula, the material may include non-stoichiometric variations of the stoichiometrically exact formula identified by the chemical name. For example, the silicon dioxide (SiO₂) material described herein may include SiOx, where x is in a range from 0.8 to 2.2.

As used herein, the term “transmission” may refer to absolute transmission (i.e., a percentage of optical power that passes through a component at a specific wavelength or subrange).

What is claimed is:

1. An optical filter, comprising:
a first material that includes at least silicon and hydrogen,
wherein the optical filter is operable to:
transmit greater than 92% of light associated with at least one subrange of a first spectral range from 1530 to 1565 nanometers (nm), and
transmit less than 5% of light associated with at least one subrange of a second spectral range from 300 to 1500 nm.

2. The optical filter of claim 1, wherein the optical filter is one of a sun-blocking filter or an amplified spontaneous emission filter.

3. The optical filter of claim 1, wherein the second spectral range is from 200 to 1500 nm.

4. The optical filter of claim 1, wherein the second spectral range is from 120 to 1500 nm.

5. The optical filter of claim 1, wherein the second spectral range is from 100 to 1500 nm.

6. The optical filter of claim 1, wherein the optical filter is further operable to:
transmit less than 15% of light associated with at least one subrange of a third spectral range from 1600 to 4000 nm.

7. The optical filter of claim 1, wherein the optical filter is further operable to:
transmit less than 15% of light associated with at least one subrange of a third spectral range from 1600 to 2500 nm.

8. The optical filter of claim 1, wherein the optical filter is further operable to:
transmit less than 15% of light associated with at least one subrange of a third spectral range from 1600 to 1800 nm.

9. The optical filter of claim 1, wherein the optical filter comprises a second material that includes at least silicon and oxygen.

10. The optical filter of claim 1, wherein the first material has a refractive index that is greater than or equal to 3.5 for light associated with the first spectral range and the second spectral range.

11. The optical filter of claim 1, wherein the optical filter includes a second material that has a refractive index that is less than or equal to 1.5 for light associated with the first spectral range and the second spectral range.

12. The optical filter of claim 1, wherein a thickness of the optical filter is less than or equal to 10 micrometers.

13. An optical communication terminal, comprising:
an optical filter that comprises a first material that includes at least silicon and hydrogen,
wherein the optical filter is operable to:
transmit greater than 92% of light associated with at least one subrange of a first spectral range from 1530 to 1565 nanometers (nm); and
transmit less than 5% of light associated with at least one subrange of a second spectral range from 300 to 1500 nm.

14. The optical communication terminal of claim 13, wherein the optical filter is one of a sun-blocking filter or an amplified spontaneous emission filter.

15. The optical communication terminal of claim 13, wherein the optical filter comprises a second material that includes at least silicon and oxygen.

16. The optical communication terminal of claim 13, wherein the second spectral range is from 100 to 1500 nm.

17. The optical communication terminal of claim 13, wherein the optical filter is further operable to:
transmit less than 15% of light associated with at least one subrange of a third spectral range from 1600 to 4000 nm.

18. The optical communication terminal of claim 13, wherein a thickness of the optical filter is less than or equal to 10 micrometers.

19. An optical node, comprising:
an optical communication terminal that includes an optical filter that comprises a first material that includes at least silicon and hydrogen,
wherein the optical filter is operable to:
transmit greater than 92% of light associated with at least one subrange of a first spectral range from 1530 to 1565 nanometers (nm); and
transmit less than 5% of light associated with at least one subrange of a second spectral range from 300 to 1500 nm.

20. The optical node of claim 19, wherein the optical filter is one of a sun-blocking filter or an amplified spontaneous emission filter.
